(19) United States
(12) Patent Application Publication
(10) Pub. No.: US 2015/0097646 A1
(43) Pub. Date: Apr. 9, 2015

(54) COIL COMPONENT

(71) Applicant: Samsung Electro-Mechanics Co., Ltd., Suwon (KR)

(72) Inventors: Geun Young PARK, Suwon (KR); Chang Yong Kwon, Suwon (KR); Jong Woo Kim, Suwon (KR); Young Min Lee, Suwon (KR); Duck Jin An, Suwon (KR)

(73) Assignee: Samsung Electro-Mechanics Co., Ltd., Suwon (KR)

(21) Appl. No.: 14/266,380

(22) Filed: Apr. 30, 2014

(30) Foreign Application Priority Data
Oct. 7, 2013 (KR) 10-2013-0119149

(51) Int. Cl. H01F 5/06; H01F 5/02

(52) U.S. Cl. CPC H01F 5/06; H01F 5/02; H01F 2005/022
USPC 336/185; 336/192

(57) ABSTRACT

There is provided a coil component having a significantly reduced size and able to be easily manufactured, the coil component including a winding part formed as a groove having a ring shape; a plurality of coils inserted into and wound in the winding part; and a sealing part filling an internal space of the winding part having the coils wound therein and embedding the coils therein.

### CROSS-REFERENCE TO RELATED APPLICATION

This application claims the benefit of Korean Patent Application No. 10-2013-0119149 filed on Oct. 7, 2013, with the Korean Intellectual Property Office, the disclosure of which is incorporated herein by reference.

### BACKGROUND

The present disclosure relates to a coil component, and more particularly, to a coil component having a significantly reduced size and able to be easily manufactured.

Various kinds of power supplies are required in various electronic devices such as televisions (TVs), monitors, personal computers (PCs), office automation (OA) devices, and the like. Therefore, such electronic devices generally include power supplies converting externally-supplied alternating current (AC) power into power appropriate for use in individual electronic appliances.

Among power supplies, a power supply using a switching mode (for example, a switched-mode power supply (SMPS)) has recently been mainly used. Such an SMPS basically includes a switching transformer.

Generally, a switching transformer may include a core and a bobbin, sizes of which may be significantly decreased as compared with a general transformer, and may supply low voltage and low current direct current (DC) power to the electronic appliance in a stable manner. Therefore, switching transformers have been widely used in the electronic appliances that have tended to be miniaturized.

Meanwhile, in a coil component according to the related art insulation between a primary coil and a secondary coil is secured by methods of laminating the coils using insulating tape or separating the primary coil and the second coil from each other by a predetermined distance.

However, in the case of using insulting tape, since processes in which the coil is wound, the insulating tape is wound, and the coil is rewound are required, a relatively complex process may be required and the coil component needs to be manually manufactured.

In addition, in the structure of separating coils from each other, since the overall volume of the coil component is expanded by an amount equal to the spaced distance, the overall size of the coil component may be increased.

Therefore, a coil component able to be automatically produced and having a significantly reduced size has been demanded.

### RELATED ART DOCUMENT

(Patent Document 1) Korean Patent Laid-Open Publication No. 2003-0075570

### SUMMARY

An aspect of the present disclosure may provide a coil component capable of easily securing insulation between coils.

An aspect of the present disclosure may also provide a coil component having a significantly reduced size.

According to an aspect of the present disclosure, a coil component may include: a winding part formed as a groove having a ring shape; a plurality of coils inserted into and wound in the winding part; and a sealing part filling an internal space of the winding part having the coils wound therein and embbeding the coils therein.

The winding part may include: a first side wall having a tubular form; a second side wall having concentricity with respect to the first side wall and forming an outer side wall of the winding part; and a connection part connecting the first side wall and the second side wall to each other.

The winding part may include at least one partition dividing a space provided between the first side wall and the second side wall, and the coils may be independently disposed in a plurality of winding spaces divided by the at least one partition.

The winding part may be divided into three winding spaces by two partitions, and the same primary or secondary coils may be wound in external winding spaces formed at both ends of the winding spaces.

The coils may include the primary coils wound in the external winding spaces and the secondary coils wound in an internal winding space disposed between the external winding spaces

The coils may be disposed in the winding part to be spaced apart from an opening in the winding part by a predetermined distance.

The coils may have lead wires at both ends thereof, and the lead wires of the coils may traverse the opening in the winding part and be led to the outside of the winding part.

The winding part may be divided into a plurality of winding spaces by a partition, and the partition may include at least one supporting groove formed in an end portion thereof and having the lead wires of the coils inserted thereinto.

The sealing part may be formed of an insulating material and may be formed between the coils wound in the winding part and lead wires of the coils.

The lead wires of the coils may be embedded in the sealing part.

The sealing part may be formed by injecting a liquid insulating resin into the winding part and then curing the liquid insulating resin.

The sealing part may be formed by inserting an insulating resin into the winding part in a semi-cured state and then curing the insulating resin.

The sealing part may be formed by inserting a fully-cured insulating material into the winding part and then injecting an insulating adhesive resin thereinto.

According to another aspect of the present disclosure, a coil component may include: a bobbin having coils wound therein and a plurality of external connection terminals fastened to an outer portion of the bobbin; a plurality of coils wound in the bobbin and having lead wires at both ends thereof, the lead wires being fastened to the external connection terminals; and a sealing part interposed between the coils wound in the bobbin and the lead wires.

The bobbin may include a winding part having a groove shape, and the winding part includes the coils wound therein and is divided into a plurality of winding spaces having concentricity.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view schematically showing a coil component according to an exemplary embodiment of the present disclosure;

FIG. 2 is a plan view showing a bottom of FIG. 1;

FIG. 3 is an exploded perspective view of the coil component shown in FIG. 1;

FIG. 4 is a schematic cross-sectional view taken along line C-C of FIG. 2; and

FIG. 5 is a partially enlarged perspective view of part A of FIG. 2.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

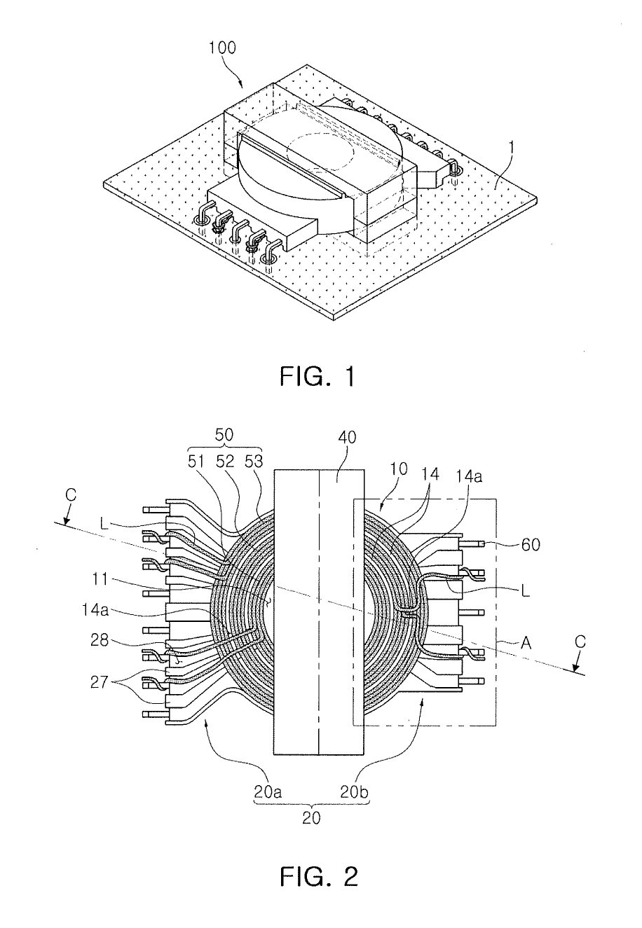

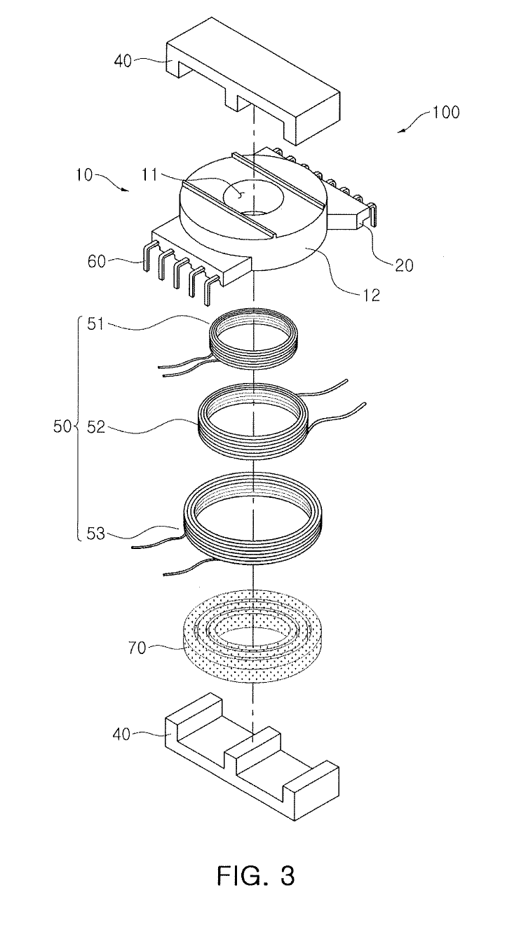

FIG. 1 is a perspective view schematically showing a coil component according to an exemplary embodiment of the present disclosure, FIG. 2 is a plan view showing a bottom of FIG. 1, and FIG. 3 is an exploded perspective view of the coil component shown in FIG. 1.

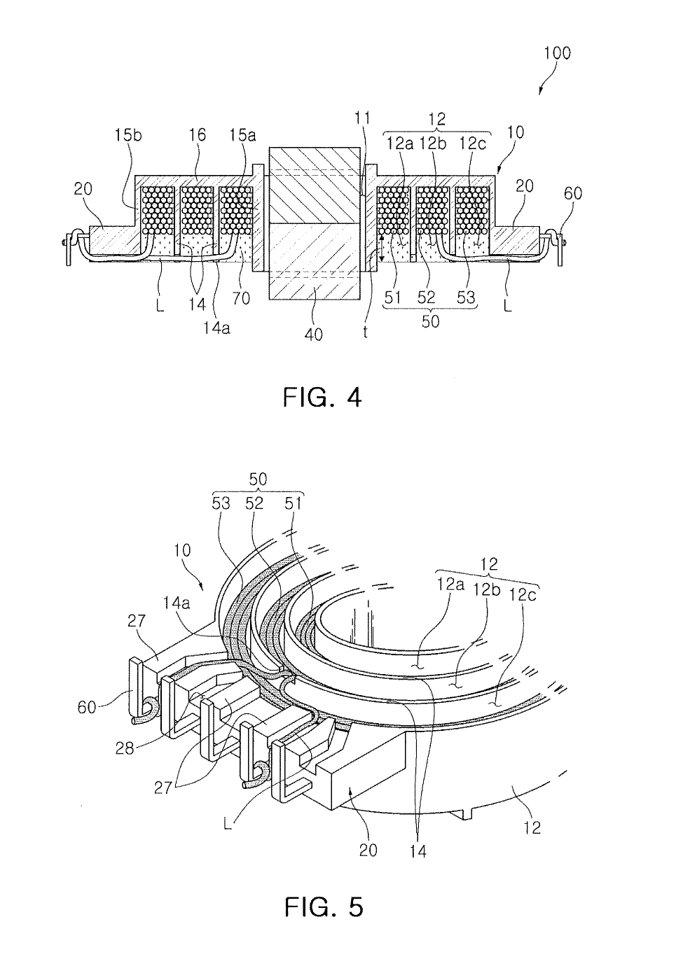

In addition, FIG. 4 is a schematic cross-sectional view taken along line C-C of FIG. 2 and FIG. 5 is a partially enlarged perspective view of part A of FIG. 2. Here, for convenience of explanation, in FIGS. 2 and 5, a sealing part is omitted and in FIG. 4, a supporting groove is added.

Referring to FIGS. 1 through 5, a coil component 100 according to an exemplary embodiment of the present disclosure may be a transformer included in a power supply (for example, SMPS) and may include a bobbin 10, a core 40, coils 50, and a sealing part 70.

The bobbin 10 may form the entire exterior of the coil component 100. The bobbin 10 may be easily manufactured by an injection molding method, but is not limited thereto. In addition, the bobbin 10 according to the exemplary embodiment may be formed of an insulating resin and may be formed of a material having high heat resistance and high withstand voltage properties.

The bobbin 10 may include a winding part 12 having the coils 50 wound therein and terminal parts 20 formed on two ends of the winding part 12.

The winding part 12 may be formed as a groove having a ring shape and a center of the winding part 12 may be provided with a through-hole 11 into which a portion of the core 40 is inserted. In addition, the winding part 12 may have the coils 50 wound therein.

More specifically, the winding part 12 according to the exemplary embodiment may include a first side wall 15a having a tubular form and forming the through-hole 11, a second side wall 15b forming an outer side wall, and a connection part 16 connecting the second side wall 15b and the first side wall 15a to each other, as shown in FIG. 4.

The first side wall 15a may be formed to be bent and extended from an inner end of the connection part 16. In addition, the second side wall 15b may be formed to be bent and extended from an outer end of the connection part 16. Here, the first side wall 15a and the second side wall 15b may have concentricity and may be disposed in a ring shape with a predetermined interval therebetween.

In addition, the winding part 12 may have at least one partition 14 formed therein. The partition 14 may be formed to have the concentricity with respect to the second side wall 15b or the first side wall 15a of the winding part 12 and may divide a space provided between the second side wall 15b and the first side wall 15a into a plurality of spaces.

The coil component 100 according to the exemplary embodiment may have a total of three winding spaces 12a, 12b, and 12c which are divided by two partitions 14. Each of the winding spaces 12a, 12b, and 12c may be used as a space in which each of the coils 50 is independently wound. Meanwhile, a configuration of the present disclosure is not limited to the three winding spaces 12a, 12b, and 12c and may be variously changed as needed.

The first side wall 15a, the second side wall 15b, and the partitions 14 may serve to support the coils 50 wound in the winding spaces 12a, 12b, and 12c at both lateral surfaces thereof and serve to secure insulation properties between the coils 50.

Meanwhile, the coil component 100 according to the exemplary embodiment may be manufactured by automatically winding the coils 50 on the bobbin 10 by an automatic winding apparatus (not shown). Therefore, each of the winding spaces 12a, 12b, and 12c may have a width sufficient to allow a nozzle of the automatic winding apparatus move easily during an automatic winding process.

In addition, ends of the partitions 14 according to the exemplary embodiment may be provided with at least one supporting groove 14a. As shown in FIGS. 2 and 5, the supporting groove 14a may be provided to lead the coils 50 wound in the winding spaces 12a and 12b, disposed internally among the three winding spaces 12a, 12b, and 12c, to external connection terminals 60.

In the coil component 100 according to the exemplary embodiment, the coils 51 and 52 wound in the winding spaces 12a and 12b inwardly disposed may traverse other winding spaces 12b and 12c and may be connected to the external connection terminals 60 disposed externally. In this case, lead wires L of the coils 50 may be supported by the partitions 14 and traverse other winding spaces 12b and 12c, and the supporting groove 14a may be provided to fix and support the coils 50.

That is, the supporting groove 14a may guide the lead wires L to the external connection terminals 60. Therefore, the supporting groove 14a may be variously formed and a size of the supporting groove 14a may be variously determined as long as it may fix movements of the lead wires L.

A plurality of supporting grooves 14a may be formed depending on the number of coils 50 inserted thereinto. Alternatively, a single supporting groove 14a having a wide width may be formed, so that the plurality of coils 50 may be inserted thereinto.

The terminal parts 20 may be formed to be extended from the winding part 12 to the outside, and may have at least one or more external connection terminals 60 fastened thereto.

According to the exemplary embodiment, two terminal parts 20 may protrude from an outer surface of the second side wall 15b of the winding part 12 to both ends of the terminal parts 20 in an outer diameter direction. The two terminal parts 20a and 20b may be symmetrical to each other with respect to the winding part 12, and any one of the two terminal parts 20a and 20b is larger than the other terminal part as needed as in the exemplary embodiment.

In addition, the two terminal parts 20 may be divided into a primary terminal part 20a to which primary coils 51 and 53 are connected and a secondary terminal part 20b to which a secondary coil 52 is connected as shown in FIG. 2.

In addition, the terminal parts 20 according to the exemplary embodiment may include a plurality of guide protrusions 27 and guide grooves 28.

The plurality of guide protrusions 27 may protrude from a lower surface of the terminal part 20 to a lower portion of the winding part 12 so as to be in parallel with each other.

The guide protrusions 27 may guide the lead wires L of the coils 50 wound in the winding part 12 in such a manner that the lead wires L may be easily disposed in the external connection terminals 60. Therefore, the guide protrusions 27 may protrude by an amount equal to or greater than a diameter of the coil 50 so as to firmly support and guide the coil 50 disposed therebetween.

The guide grooves 28 may be formed by the guide protrusions 27. That is, the guide grooves 28 may be grooves formed between the guide protrusions 27 adjacent to each other.

The guide grooves 28 may be used as paths through which the lead wires L of the coils 50 wound in the winding part 12 are led to the outside of the terminal part 20. That is, the lead wires L led from the winding part 12 may be inserted into the guide grooves 28, pass through the guide grooves 28, and subsequently, be connected to the external connecting terminals 60. Therefore, the guide grooves 28 may have widths greater than diameters of the coils 50.

The external connection terminals 60 may be mounted on a substrate 1 (FIG. 1) and may be electrically connected to other components provided on the substrate 1.

The external connection terminals 60 may be fastened to the terminal part 20 in such a manner that they protrude outwardly from the terminal part 20. The exemplary embodiment describes a case in which the external connection terminals 60 are fastened to the terminal part 20 such that the external connection terminals 60 are disposed in an outer diameter direction of the through-hole 11, by way of example. However, the present disclosure is not limited thereto. That is, various applications may be made. For example, the external connection terminals 60 may be fastened to an upper surface or the lower surface of the terminal part 20.

The bobbin 10 according to the exemplary embodiment as described above may be easily manufactured by an injection molding method, but is not limited thereto. In addition, the bobbin 10 according to the exemplary embodiment may be formed of an insulating resin and may be formed of a material having high heat resistance and high withstand voltage characteristics. Examples of a material for forming the bobbin 10 may include polyphenylenesulfide (PPS), liquid crystal polyester (LCP), polybutyleneterephthalate (PBT), polyethyleneterephthalate (PET), phenolic resin, and the like, but are not limited thereto.

The core 40 may be partially inserted into the through-hole 11 of the bobbin 10 and form a magnetic path electromagnetically coupled to the coils 50.

The core 40 according to the exemplary embodiment may be configured as a pair of cores as shown in FIG. 3. The pair of cores 40 may be partially inserted into the through-hole 11 of the bobbin 10 to be coupled to each other so as to contact each other. For example, although the exemplary embodiment describes a case in which the ‘EE’ core is used byway example, the present disclosure is not limited thereto, but may be applied to various types of core 40 such as an ‘EI’ core, a ‘UU’ core, a ‘UI’ core, and the like.

The core 40 may be formed of Mn—Zn based ferrite having higher permeability, lower loss, higher saturation magnetic flux density, and higher stability, and requiring a lower production cost, as compared with those of other materials. However, in an exemplary embodiment of the present disclosure, a shape or a material of the core 40 is not limited.

The coils 50 may be wound in the winding part 12 of the bobbin 10 and include the primary coils 51 and 53 and the secondary coil 52.

Each of the primary coils 51 and 53 and the secondary coil 52 may include a plurality of individual coils that are electrically insulated from each other. Here, the number of each of the primary coils 51 and 53 and the secondary coil 52 may be appropriately changed as needed.

The primary coils 51 and 53 according to the exemplary embodiment may be wound in the external winding spaces 12a and 12c formed at both ends of the three winding spaces 12a, 12b, and 12c. Here, the external winding spaces 12a and 12c may be divided into an external winding space 12c and an internal winding space 12a.

The second coil 52 may be wound in the internal winding space 12b disposed in the middle of the winding spaces. That is, the second coil 52 may be interposed between the external winding space 12c and the internal winding space 12a. Thereby, the primary coils 51 and 53 and the secondary coil 52 may secure insulation therebetween by the partitions 14 described below.

As described above, in a case in which the primary coils 51 and 53 are disposed in two external winding spaces 12a and 12c, respectively, and the secondary coil 52 is disposed in the internal winding space 12b between the two external winding spaces 12a and 12c, an amount of leakage current between the primary and secondary coils may be significantly reduced. However, the present disclosure is not limited thereto. Various applications may be made as needed. For example, the secondary coil 52 may be disposed in the external winding spaces 12a and 12c or may be disposed in both of the internal and external winding spaces.

In addition, the lead wires L of both ends of the coils 50 according to the exemplary embodiment of the present disclosure may traverse an entrance of the winding part 12, that is, an opening thereof, and may be led to the external connection terminals 60 of the terminal part 20. To this end, the partitions 14 of the winding part 12 may be provided with the at least one supporting groove 14a, and the lead wires L of the coils 50 may be inserted into and fixed to the supporting groove 14a and may be led to the terminal part 20.

The primary coils 51 and 53 wound in the external winding spaces 12a and 12c, respectively, may be led to the primary terminal part 20a and the secondary coil 52 wound in the internal winding space 12b may be led to the secondary terminal part 20b.

Accordingly, as shown in FIG. 2, the primary coil 51 wound in the internal winding space 12a may traverse openings in the internal winding space 12b having the secondary coil 52 wound therein and the external winding space 12c having the primary coil 53 wound therein.

In addition, the secondary coil 52 may traverse an opening in the external winding space 12c having the primary coil 53 wound therein.

In addition, the lead wires L according to the exemplary embodiment may be inserted into the supporting groove 14a and at the same time, may be embedded in a sealing part 70 described below. Therefore, movements of the lead wires L may be completely fixed by the sealing part 70.

Meanwhile, although the exemplary embodiment describes a case in which the partition 14 includes the supporting groove 14a by way of example, the configuration of the present disclosure is not limited thereto. That is, various applications may be made as needed. For example, the lead wires L may be supported by the end of the partition 14 to be led, without the supporting groove 14a. In this case, some or all of the lead wires L may be exposed to the outside of the sealing part 70.

In addition, the coils 50 according to the exemplary embodiment may be wound in the winding part 12 to be spaced apart from the entrance (or the lead wires) of the winding part 12 by a predetermined distance. That is, each of the coils 50 may not be wound to the entrance of the winding part 12 and may be wound to have a spaced distance t as shown in FIG. 4.

The configuration described above may be provided to secure insulation between the coils 50 wound in the winding part 12 and the lead wire L of another coil 50 traversing the entrance of the winding part 12. Therefore, the spaced distance may be defined as a distance capable of securing insulation between the primary coil 50 and the second coil 50.

In addition, in the coil component 100 according to the exemplary embodiment of the present disclosure, the sealing part 70 may be formed between the coils 50 wound in the winding part 12 and the lead wire L of the coil 50 traversing the opening in the winding part 12 as described above. Therefore, the spaced distance t according to the exemplary embodiment may be formed as a shortest distance capable of securing insulation between the coils 50 by the sealing part 70.

As the coils 50 according to the exemplary embodiment, general insulated coils (for example, polyurethane wires), or the like, or twisted wire coils formed by twisting several strands of wires (for example, a Litz wire, or the like) may be used.

Particularly, in the coil component 100 according to the exemplary embodiment, since the partitions 14 and the sealing part 70 to be described below are interposed between the primary coils 51 and 53 and the secondary coil 52, even in a case in which the general insulated coil is used, insulating reliability between the primary and secondary coils may be easily secured.

Therefore, a multi-insulated coil (for example, a triple insulated wire (TIW)) having high insulation properties, but causing an increase in production costs needs not to be used, such that production costs may be significantly reduced.

The sealing part 70 may fill the interior of the winding part 12.

The coils 50 wound in the winding part 12 may be fixed in the winding part 12 by the sealing part 70. In addition, insulating properties between the primary coils 51 and 53 and the secondary coil 52 wound in the winding part 12 may be further secured by the sealing part 70.

In addition, as described above, the sealing part 70 may be formed between the coils 50 wound in the winding part 12 and the lead wire L traversing the opening in the winding part 12 to secure insulating properties therebetween.

Therefore, the sealing part 70 according to the exemplary embodiment may be formed of a material having insulating properties. For example, the sealing part 70 may be formed of an insulating resin, and more particularly, may be formed of an epoxy resin, a silicon resin, or the like.

The sealing part 70 described above may be formed by injecting a liquid insulating resin into the winding part 12 and then curing the liquid insulating resin. However, the present disclosure is not limited thereto, but an insulating resin having a paste or powder form may be used.

In addition, various applications may be made. For example, the sealing part 70 may be formed by inserting a soft insulating resin into the winding part in a semi-cured state 12 and then curing the soft insulating resin or inserting a fully-cured insulating material into the winding part 12 and then injecting an insulating adhesive resin into a gap between the insulating material and the bobbin 10. Here, the insulating material may be configured of a single part or a plurality of parts.

The coil component according to an exemplary embodiment of the present disclosure configured as described above may have the three divided winding spaces. In addition, the secondary coil may be disposed in the center of the winding spaces and the primary coils may be disposed in both ends of the winding spaces. Therefore, the amount of leakage current may be decreased as compared with the related art case in which the primary coil and the secondary coil are sequentially disposed.

In addition, in the coil component according to an exemplary embodiment of the present disclosure, the sealing part may be formed by winding the coil and then filling the winding part with the insulating resin. Therefore, insulation between the coils in the winding part and insulation between the wound coil and the lead wire of the coil may be easily secured.

In addition, the sealing part described as above is used, such that there is no need to repeatedly dispose the insulating tape between the coils as in the related art, and since the coils may be easily wound by using the automatic winding apparatus, the coil component may be easily manufactured.

In addition, since insulation between the primary and secondary coils may be secured by the sealing part, the distance between the primary and secondary coils may be significantly reduced, whereby the overall volume of the coil component may be significantly reduced.

Next, a method of manufacturing a coil component according an exemplary embodiment of the present disclosure will be described with reference to FIGS. 4 and 5.

First, the bobbin 10 including the winding part 12 may be prepared, the winding part 12 being formed as a groove having a ring shape. In addition, the coils 50 may be wound in the bobbin 10 using an automatic winding apparatus (not shown).

Here, the automatic winding apparatus may first connect the coils 50 to the external connection terminals 60. Then, the automatic winding apparatus may move to the winding part 12 to wind the coils 50 in the winding part 12. In this case, a nozzle of the automatic winding apparatus may be inserted into one of the winding spaces 12a, 12b, and 12c and move along the winding spaces 12a, 12b, and 12c to wind up the coils 50 in winding spaces 12a, 12b, and 12c.

When the winding of the coils 50 in the winding part 12 is completed, the nozzle of the automatic winding apparatus may move to the external connection terminals 60 to connect the coils 50 to the external connection terminals 60. In this case, the lead wires L of the coils 50 led to the external connection terminals 60 may be disposed in such a manner that they traverse the entrance (opening) of the winding part 12. In addition, the lead wires L may be inserted into the supporting groove 14a formed in the partitions 14. This process may be equally applied to a process in which the coils 50 are led into the winding part 12.

When the winding of the coils 51, 52, and 53 in all of the winding spaces 12a, 12b, and 12c is completed by repeating the above-mentioned process, the sealing part 70 may be formed subsequently in the winding part 12.

The sealing part 70 may be formed by a method of injecting a liquid insulating resin into the winding part 12 and then curing the liquid insulating resin.

When the sealing part 70 is formed, the core 40 is coupled to the bobbin 10, such that the coin component 100 according to the exemplary embodiment may be completed.

The coil component according to the present disclosure as described above is not limited to the above-mentioned embodiments, but may be variously applied.

For example, the foregoing exemplary embodiment describes a case in which the winding part is formed such that the opening thereof is disposed in a lower portion of the bobbin by way of example. However, the present disclosure is not necessarily limited thereto. That is, the opening in the winding part may be disposed in the upper surface of the bobbin.

In addition, in the coil component according to the foregoing exemplary embodiment, a case in which the winding part has a cylindrical tube shape, byway of example. However, the present disclosure is not necessarily limited thereto. That is, the coil component may be variously formed. For example, the coil component may be formed in a polygonal pillar shape.

In addition, in the foregoing exemplary embodiment, among coil components, a transformer is exemplified by way of example. However, the present disclosure is not limited thereto, but may be variously applied to a component having a wound coil, such as a choke coil, an inductor, or the like, and an electronic device including the same.

As set forth above, the coil component according to exemplary embodiments of the present disclosure may have three divided winding spaces. In addition, the secondary coil may be disposed in the center of the winding spaces and the primary coils may be disposed in both ends of the winding spaces. Therefore, the amount of leakage current may be decreased as compared with the related art case in which the primary coil and the secondary coil are sequentially disposed.

In addition, in the coil component according to an exemplary embodiment of the present disclosure, the sealing part may be formed by winding the coils and then filling the winding part with an insulating resin. Therefore, insulation between the coils in the winding part and insulation between the wound coil and the lead wire of the coil may be easily secured.

In addition, the sealing part described as above is used, such that there is no need to repeatedly dispose insulating tape between the coils as in the related art, and since the coils may be easily wound by using an automatic winding apparatus, the coil component may be easily manufactured.

In addition, since insulation between the primary and secondary coils may be secured by the sealing part, a distance between the primary and secondary coils may be significantly reduced, whereby the overall volume of the coil component may be significantly reduced.

While exemplary embodiments have been shown and described above, it will be apparent to those skilled in the art that modifications and variations could be made without departing from the spirit and scope of the present disclosure as defined by the appended claims.

What is claimed is:

1. A coil component comprising:
a winding part formed as a groove having a ring shape;
a plurality of coils inserted into and wound in the winding part; and
a sealing part filling an internal space of the winding part having the coils wound therein and embedding the coils therein.

2. The coil component of claim 1, wherein the winding part includes:
a first side wall having a tubular form;
a second side wall having concentricity with respect to the first side wall and forming an outer side wall of the winding part; and
a connection part connecting the first side wall and the second side wall to each other.

3. The coil component of claim 2, wherein the winding part includes at least one partition dividing a space provided between the first side wall and the second side wall, and
the coils are independently disposed in a plurality of winding spaces divided by the at least one partition.

4. The coil component of claim 3, wherein the winding part is divided into three winding spaces by two partitions, and the same primary or secondary coils are wound in external winding spaces formed at both ends of the winding spaces.

5. The coil component of claim 4, wherein the coils include the primary coils wound in the external winding spaces and the secondary coils wound in an internal winding space disposed between the external winding spaces.

6. The coil component of claim 1, wherein the coils are disposed in the winding part to be spaced apart from an opening in the winding part by a predetermined distance.

7. The coil component of claim 6, wherein the coils have lead wires at both ends thereof, and the lead wires of the coils traverse the opening in the winding part and are led to the outside of the winding part.

8. The coil component of claim 7, wherein the winding part is divided into a plurality of winding spaces by a partition, and the partition includes at least one supporting groove formed in an end portion thereof and having the lead wires of the coils inserted thereinto.

9. The coil component of claim 1, wherein the sealing part is formed of an insulating material and is formed between the coils wound in the winding part and lead wires of the coils.

10. The coil component of claim 1, wherein lead wires of the coils are embedded in the sealing part.

11. The coil component of claim 1, wherein the sealing part is formed by injecting a liquid insulating resin into the winding part and then curing the liquid insulating resin.

12. The coil component of claim 1, wherein the sealing part is formed by inserting an insulating resin into the winding part in a semi-cured state and then curing the insulating resin.

13. The coil component of claim 1, wherein the sealing part is formed by inserting a fully-cured insulating material into the winding part and then injecting an insulating adhesive resin thereinto.

14. A coil component comprising:
a bobbin having coils wound therein and a plurality of external connection terminals fastened to an outer portion of the bobbin;
a plurality of coils wound in the bobbin and having lead wires at both ends thereof, the lead wires being fastened to the external connection terminals; and
a sealing part interposed between the coils wound in the bobbin and the lead wires.

15. The coil component of claim 14, wherein the bobbin includes a winding part having a groove shape, and the winding part includes the coils wound therein and is divided into a plurality of winding spaces having concentricity.
